(19) United States
(12) Patent Application Publication
(10) Pub. No.: US 2020/0362597 A1
(43) Pub. Date: Nov. 19, 2020

(54) LOCKING MECHANISM FOR SLIDING DOORS AND WINDOWS

(71) Applicant: JOFEBAR S.A., Matosinhos (PT)

(72) Inventor: António Manuel TAVARES NUNES, Matosinhos (PT)

(73) Assignee: JOFEBAR S.A., Matosinhos (PT)

(21) Appl. No.: 16/854,949

(22) Filed: Apr. 22, 2020

(30) Foreign Application Priority Data
May 17, 2019 (EP) 19398006.7

(51) Int. Cl. E05B 65/08; E05B 15/08

(52) U.S. Cl. CPC E05B 65/08; E05Y 2900/148; E05Y 2900/132; E05B 15/08

(57) ABSTRACT

A locking mechanism for sliding doors and windows includes a lock with a lock cylinder having a key hole for the key. The lock includes a tab and a cylinder pin. The locking mechanism further includes a toggle box, a track, a stopper, a chamber and an operating latch, a blocking toggle, an operating handle and left and right side faces. The key includes a key shaft, key head, a bore, an inlet and key teeth. The abutment of the cylinder pin on the stopper promotes the blocking in the locking mechanism which presents reduced dimensions for application in modern design frame structures.

### FIELD

The disclosure relates to locking mechanisms for sliding doors and windows.

### BACKGROUND

Various locking mechanisms for sliding doors and windows exist in the art.

EP 1 679 969 describes a catch locking mechanism that comprises a housing, a slidable member, at least a part of which is positioned inside the housing, a key cylinder arranged to receive, in use, a key, a catch arranged to engage, in use, a mating socket, fixing means for securing the catch to the slidable member, and biasing means arranged to adjust, in use, the position of the slidable member. The key cylinder is arranged such that, in use, the key received is only removable from the key cylinder at predetermined positions, between which the key cylinder is arranged to rotate.

The biasing means are fundamental to the functioning of the catch locking mechanism of the EP 1 679 969. The springs that generally are part of these biasing means suffer from fatigue problems and may lead to malfunction and control issues of the assembly.

The absence of biasing means in the locking mechanism of the present invention provides a better handling over time.

Many of the existing locking mechanisms present dimensions that do not allow its placement in the reduced spaces of the modern frames.

The working of the locking mechanisms of the prior art involves structures with considerable bulk which are an obstacle to its placement in narrower frames of more minimalist design.

The complex design of some of the locking mechanisms of the prior art does not expedite its blocking and unblocking process when interacting with the frame structures.

The locking mechanisms whose construction involves difficult blocking and unblocking processes cause a decrease in the operation capability of the sliding doors and windows there-between.

Some of the prior art locking mechanisms present a construction and working which may facilitate their breach and consequent opening, whereby they are unreliable.

### SUMMARY

The purpose of the present invention is to provide a locking mechanism for sliding doors and windows which allows to overcome the disadvantages and problems of the prior art and which meets the needs of an agile working of the frame structures.

An object of the present invention is to provide a locking mechanism for sliding doors and windows which presents dimensions which allow their placement in the reduced spaces of the modern frames.

A further object of the present invention is to provide a locking mechanism for sliding doors and windows, which work does not imply bulky structures that are an obstacle to the placement in narrower frames of further minimalist design.

An object of the present invention is to provide a locking mechanism for sliding doors and windows which allows to speed up the process of its blocking and unblocking in the context of the interaction with said doors and windows of the frame structures, wherein it is intended that said doors or windows can move there-between without any obstructions.

A further object of the present invention is to provide a locking mechanism for sliding doors and windows which blocking and unblocking process does not compromise the need for a minimalist structural dimension and which has no negative implications on the working capability of the sliding doors and windows where it is inserted.

An object of the present invention is to provide a locking mechanism for sliding doors and windows which presents a high tamper resistance and which presents a high reliability.

A further object of the present invention is to provide a locking mechanism for sliding doors and windows which presents left and right smooth side faces.

Briefly, the locking mechanism for sliding doors and windows of the present invention allows to achieve a blocking and unblocking without restrictions nor limitations when inserted into frame structures, it being able to be vertically mounted in very small spaces without implications to the good working and/or good performance of said sliding doors or windows, it being of simpler working, having smaller dimensions, being easier to manufacture and assemble and having a lower cost.

The present invention thus seeks to achieve the above mentioned objects and overcome the disadvantages of the locking mechanisms for sliding doors and windows trough a solution according to the disclosure.

The locking mechanism for sliding doors and windows comprises a locking mechanism with a lock cylinder, having a key hole for the key, wherein it comprises a tab and a cylinder pin, integrated in said lock, a toggle box, a track, a stopper, a second chamber, an operating latch, a blocking toggle, an operating handle, left and right side faces, a first chamber, a body portion, a third chamber, a fourth chamber and screws, wherein said locking mechanism comprises a key, which comprises a key shaft, key head, a bore, an inlet and key teeth, wherein:
the lock is inserted close to the left side face of said blocking toggle;
the operating handle of said blocking toggle is extended outwardly in straight line in the vicinity of said right side face;
the tab is partially housed in a first chamber and partly in a second chamber;
the tab is arranged so as to be prevented from displacing in said first chamber;
the tab is arranged so as to be able to be displaced in said second chamber;
the cylinder pin is arranged to be displaced in the track, when it is aligned with said tab in the unblocking position of said locking mechanism;
the first chamber, the second chamber and the track present different heights, widths, lengths and shaping and are superimposed;
the cylinder pin is arranged in order to be abutted against a stopper which is aligned with said track, when the tab is arranged perpendicularly with respect to the cylinder pin, in the blocking position of said locking mechanism;
the operating latch is arranged in order to be displaced together with the blocking toggle in the longitudinal direction;
the blocking toggle is arranged in such a way with respect to the toggle box that its longitudinal movement is achieved by the displacement of said operating handle;
the body portion of the blocking handle is joined to this latter by means of screws;
the third chamber and the fourth chamber are arranged so as to allow the movement of said body portion and of the adjacent portion of the body portion in the longitudinal direction;
the left and right side faces of the blocking toggle are substantially smooth;
the width of said locking mechanism is substantially reduced, preferably 14 mm;
the diameter of said lock is substantially reduced, preferably 6 mm. The key comprises a key shaft, a key head, a bore, an inlet and key teeth.

### BRIEF DESCRIPTION

The disclosure may be better understood and implemented with reference to the accompanying drawings which illustrate a preferred embodiment thereof by way of a non-limiting example.

FIG. 1 is a longitudinal section of the locking mechanism for sliding doors and windows with key according to the present invention, the lock of said locking mechanism being in the blocked position;

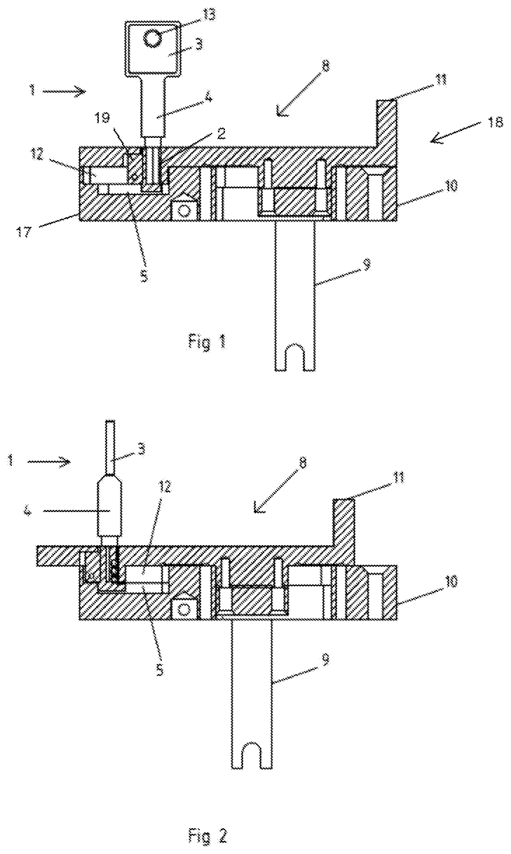

FIG. 2 is a longitudinal section of the locking mechanism for sliding doors and windows, the lock thereof being in the unblocked position;

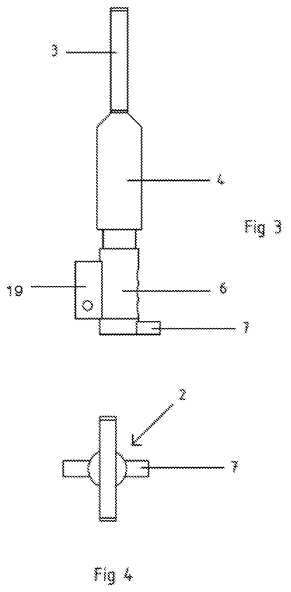

FIG. 3 is a side view of the lock with key in the unblocked position;

FIG. 4 is a top view of the lock with key in the unblocked position;

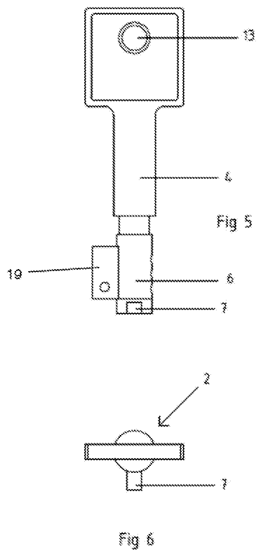

FIG. 5 is a side view of the lock with key in the blocked position;

FIG. 6 is a top view of the lock with key in the blocked position;

FIG. 7 is a longitudinal section view of the locking mechanism for sliding doors and windows with the lock in the blocked position;

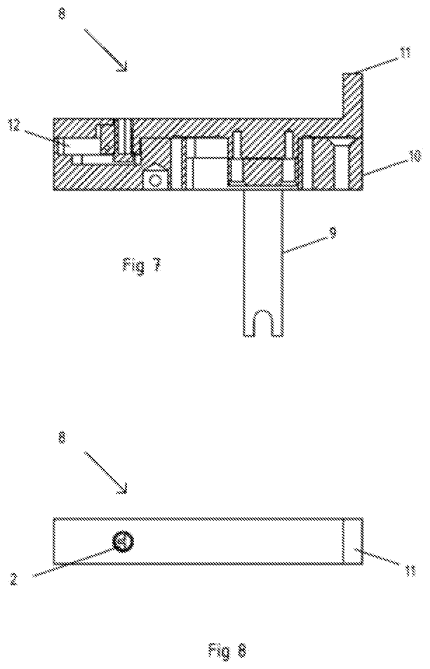

FIG. 8 is a top view of the locking mechanism for sliding doors and windows with the lock in the blocked position;

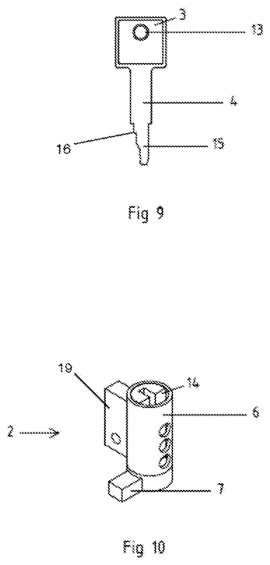

FIG. 9 is a view of the key; and

FIG. 10 is an isometric view of the lock without key in the blocked position;

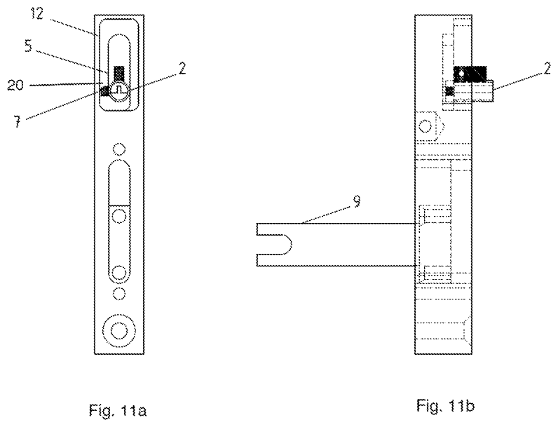

FIG. 11a is a sectional top view of the locking mechanism for sliding doors and windows with the lock in the blocked position;

FIG. 11b is a side view of the toggle box handle with the lock in the blocked position;

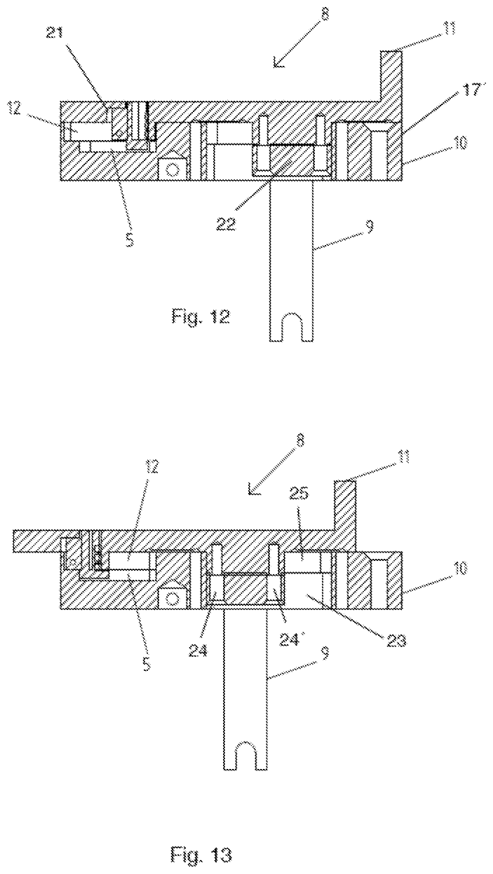

FIG. 12 is a longitudinal section of the locking mechanism for sliding doors and windows without key, the lock thereof being in the blocked position;

FIG. 13 is a longitudinal section of the locking mechanism for sliding doors and windows without key, the lock thereof being in the unblocked position;

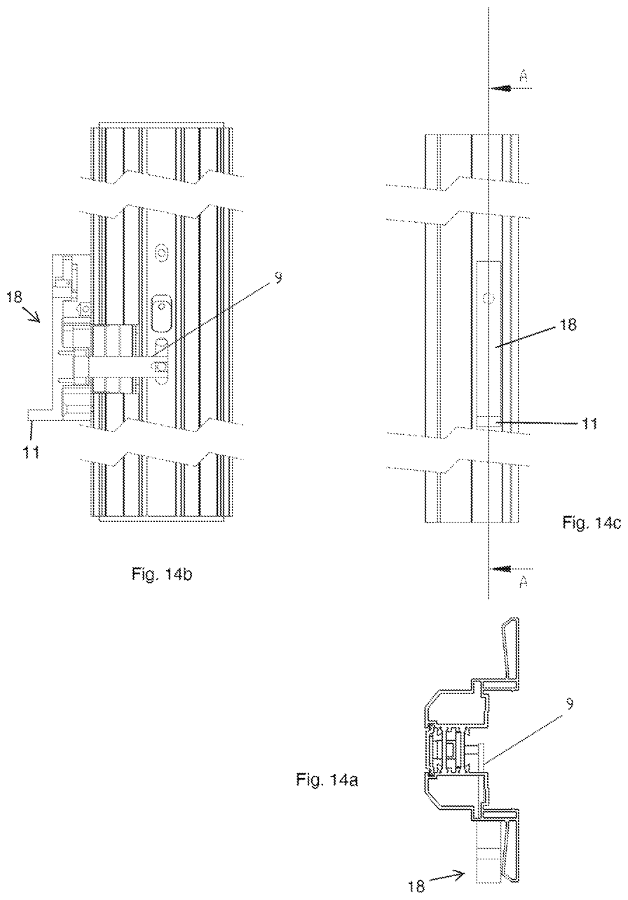

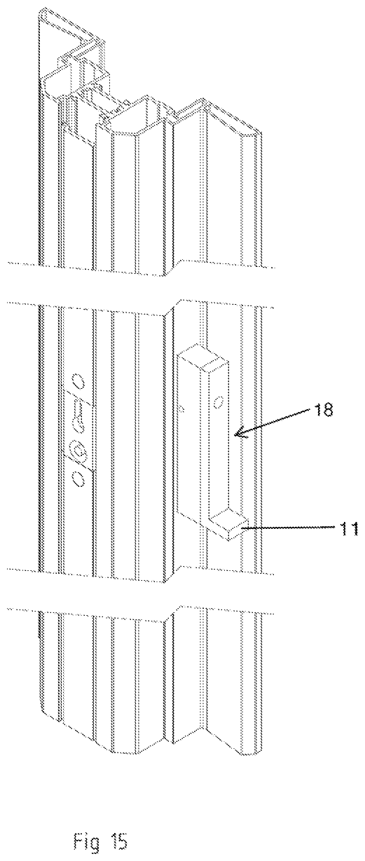

FIG. 14a is a sectional view of the locking mechanism for sliding doors and windows inserted in a frame structure;

FIG. 14b is a further view of the locking mechanism inserted in a frame structure;

FIG. 14c is another view of the locking mechanism inserted in a frame structure; and

FIG. 15 is a perspective view of the locking mechanism for sliding doors and windows inserted in a frame structure.

### DETAILED DESCRIPTION

It will now be made a detailed description of a preferred embodiment of the locking mechanism 18 for sliding doors and windows according to the present invention.

The locking mechanism 18 for sliding doors and windows of the present invention has the advantage of allowing the blocking and the unblocking without restrictions nor limitations when inserted into frame structures, in particular structures of sliding windows or doors, it being able to be mounted in very small spaces without implications for the good working and/or performance of said sliding doors or windows, it being simpler and of smaller dimensions, easier to fabricate and having a cost more reduced with respect to existing locking mechanisms for that purpose.

Such as represented in FIG. 1, the upper portion of the blocking toggle 8, of substantially rectangular shape and left and right smooth side faces 17, 17′, includes an operating handle 11 and the lower part of the blocking toggle includes a toggle box 10, an operating latch 9, a second chamber 12 and a track 5. A user fits the key 1 in the key hole 14, such as represented in FIG. 1, and rotates the same into 90° in the counter-clockwise direction. This action causes the displacement of the cylinder pin 7 from the stopper 20 in the track 5 to a position where it is aligned with the tab 19 and enables the movement of the toggle 10.

Such as represented in FIG. 2, a user can again displace the toggle 10 to the position shown in FIG. 1. Then the user can engage the key 1 in the key hole 14 and rotate the same into 90° in the clockwise direction. This action causes the displacement of the cylinder pin 7 inside the track 5 to a position in which said cylinder pin 7 is arranged into 90° with respect to the tab 19 and abutted on stopper 20, it being thus prevented the movement of the toggle 10.

Particularly with respect to the cylinder pin and to the track on which it is displaced, they can take on other configurations within the scope of the invention, always in order to enable the blocking and unblocking of locking mechanisms inserted into frames that may enable an efficient working within the mentioned purposes.

The above described embodiment is illustrative and it is not limitative. Many variations are possible to the locking mechanism for sliding doors and windows shown in the drawings, which are within the scope of this invention such as defined in the claims.

### NUMERICAL REFERENCES

1—Key
2—Lock
3—Key head
4—Key shaft
5—Track
6—Lock cylinder
7—Cylinder pin
8—Blocking toggle
9—Operating latch
10—Toggle box
11—Operating handle
12—Second chamber
13—Bore
14—Key hole
15—Inlet
16—Key teeth
17, 17′—Left and right smooth side faces
18—Locking mechanism
19—Tab
20—Stopper
21—First chamber
22—Body portion
23—Third chamber
24—Screw
24′—Screw
25—Fourth chamber

1. A locking mechanism for sliding doors and windows comprising:
a lock with a lock cylinder having a key hole for the key, including a tab and a cylinder pin integrated in said lock, a toggle box, a track, a stopper, a second chamber, an operating latch, a blocking toggle, an operating handle, left and right side faces, a first chamber, a body portion, a third chamber, a fourth chamber and screws, and a key which includes a key shaft, key head, a bore, an inlet and key teeth, wherein,
the lock is inserted in the blocking toggle proximate to the left side face of said blocking toggle;
the operating latch is configured to be displaced together with the blocking toggle;
the blocking toggle is configured with respect to the toggle box that longitudinal movement of the blocking toggle is effected by the displacement of said operating handle;
the body portion is attached to the blocking toggle by the screws;
the third chamber and the fourth chamber in the toggle box are configured to allow movement of said body portion and a body portion adjacent part in the blocking toggle;
the left and right side faces of the blocking toggle are substantially smooth;
wherein
the lock comprises a tab;
the operating handle of said blocking toggle is configured to be extended outwardly in a straight line in proximate to said right side face of the blocking toggle;
the tab of the lock is partially housed in a first chamber in the blocking toggle and partially housed in a second chamber in the toggle box;
the tab is configured to be prevented from displacing in said first chamber;
the tab is configured to be displaced in said second chamber;
the first chamber, the second chamber and the track present different heights, widths, lengths and shaping and are superimposed;
the cylinder pin is configured to be displaced in the track in the toggle box, when said cylinder pin is aligned with said tab in the unblocking position of said locking mechanism; and
the cylinder pin is configured to be abutted against a stopper in the toggle box which is aligned with said track, when the tab is perpendicular with respect to the cylinder pin in the blocking position of said locking mechanism.

2. The locking mechanism for sliding doors and windows according to claim 1, wherein the width of said locking mechanism is approximately 14 mm.

3. The locking mechanism for sliding doors and windows according to claim 1, wherein the diameter of said lock is approximately 6 mm.
